(19) United States
(12) Patent Application Publication
(10) Pub. No.: US 2009/0249248 A1
(43) Pub. Date: Oct. 1, 2009

(54) USER DIRECTED REFINEMENT OF SEARCH RESULTS WHILE PRESERVING THE SCOPE OF THE INITIAL SEARCH

(75) Inventors: ERIK J. BURCKART, RALEIGH, NC (US); ANDREW J. IVORY, WAKE FOREST, NC (US); TODD E. KAPLINGER, RALEIGH, NC (US); MAXIM A. MOLDENHAUER, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/054,751

(22) Filed: Mar. 25, 2008

(51) Int. Cl. G06F 17/30; G06F 3/048

(52) U.S. Cl. 715/810; 707/5; 707/E17.017

(57) ABSTRACT

A Web document can be accessed that contains search results determined by a search engine. The Web document can then be altered to contain software code for a refinement menu that contains refinement commands for the search results. The altered Web document can then be presented within a Web-based search interface. A user-selection can be received from the Web-based search interface. If the user-selection is from the refinement menu, then the refinement command can be executed upon the search results.

### BACKGROUND OF THE INVENTION

The present invention relates to the field of Web searches and, more particularly, to a user directed refinement of search results while preserving the scope of the initial search.

With the astronomical amount of information available on the Internet, the ability to efficiently find information is a key issue. The key word searches executed by search engines typically return a large number of search results. Current search engines offer a user limited options for locating the desired information within the group of search results.

One such option available to users is the ability to search for specific terms contained in the group of search results. This option, however, relies upon the ability of a user to correctly guess a term and/or key word used in the metadata of the search result they desire. Further, the execution of a search within search results requires additional time and resources because the original search is re-executed with the inclusion of the secondary term.

Another popular option is to provide the capability of finding other Web documents that are similar to a certain search result. However, this option can easily introduce search results that are outside the scope of the original search. For example, selecting the “Similar Pages” option for a search result in a search conducted for “porcelain doll crafting” can generate a page of search results containing links for guitar equipment and an Australian school rally. Such results were not contained in the search results of the initial search and have been included due to a key word match extraneous to the entered search criteria.

### BRIEF SUMMARY OF THE INVENTION

One aspect of the present invention can include a method for providing a refinement capability for a set of search results while preserving the scope of the search criteria. Such a method can include accessing a Web document that contains search results determined by a search engine. The Web document can then be altered to contain software code for a refinement menu that contains refinement commands for the search results. The altered Web document can then be presented within a Web-based search interface. A user-selection can be received from the Web-based search interface. If the user-selection is from the refinement menu, then the refinement command can be executed upon the search results.

Another aspect of the present invention can include a system that provides a refinement capability for a set of search results while preserving the scope of the search criteria. Such a system can include a search engine, a search results refinement component, and a Web-based search interface. The search engine can be configured to determine search results for user-provided search criteria. The search results refinement component can be configured to allow a user-directed refinement of the search results. The user-directed refinement can remove an item from the search results without invoking the search engine. The Web-based search interface can be configured to present the search results and to provide a mechanism for a user to execute a user-directed refinement upon the search results.

Yet another aspect of the present invention can include a software application that provides a refinement capability for a set of search results while preserving the scope of the search criteria. Such a software application can include a refinement menu generator, a display page modifier, and a refinement applicator. The refinement menu generator can be configured to determine user-selectable menu items to be presented in a refinement menu. The display page modifier can be configured to enable the presentation of the refinement menu within a Web-based search interface. The refinement applicator can be configured to restrict the search results displayed in the Web-based search interface based upon a user-selection from the refinement menu.

### BRIEF DESCRIPTION OF THE SEVERAL VIEWS OF THE DRAWINGS

FIG. 1 is a schematic diagram illustrating a system for providing a refinement capability for a set of search results while preserving the scope of the search criteria in accordance with embodiments of the inventive arrangements disclosed herein.

FIG. 2 is a schematic diagram illustrating a search results refinement component in accordance with an embodiment of the inventive arrangements disclosed herein.

FIG. 3 is a flow chart of a method for providing a refinement capability for a set of search results while preserving the scope of the search criteria in accordance with an embodiment of the inventive arrangements disclosed herein.

FIG. 4 is a flow chart of a method outlining the interactions of a search results refinement component in accordance with an embodiment of the inventive arrangements disclosed herein.

FIG. 5 is an example depicting the enablement of a refinement menu in accordance with an embodiment of the inventive arrangements disclosed herein.

FIG. 6 is a collection of illustrations that graphically depict the refinement of search results in accordance with an embodiment of the inventive arrangements disclosed herein.

### DETAILED DESCRIPTION OF THE INVENTION

The present invention discloses a solution that provides a refinement capability for a set of search results while preserving the scope of the search criteria. The search results can be generated by a search engine for user-entered search criteria. Information regarding key words can be gathered from the search results as potential refinement menu commands. The Web document for displaying the search results can be modified to contain additional code that supports the refinement menu and its commands. User-selection of a command from the refinement menu can remove matching search results and the display can be adjusted accordingly. Further, refinements made to the search results can occur asynchronously and without the need to re-execute the original search.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

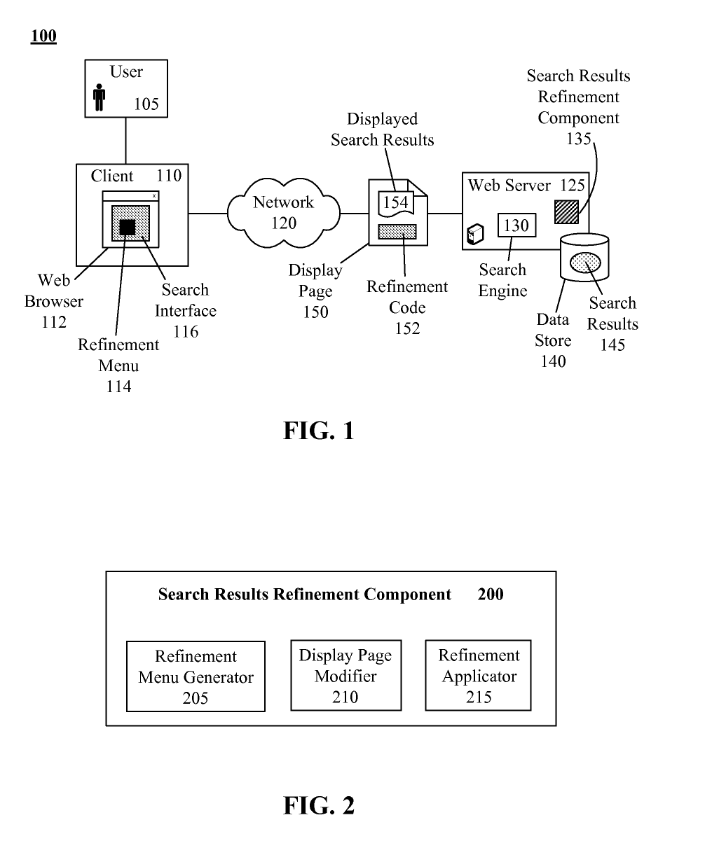

FIG. 1 is a schematic diagram illustrating a system 100 for providing a refinement capability for a set of search results 145 while preserving the scope of the search criteria in accordance with embodiments of the inventive arrangements disclosed herein. In system 100, a user 105 can use a refinement menu 114 displayed in a search interface 116 of a Web browser 112 to refine a set of search results 145 generated by a search engine 130.

The user 105 can access the Web browser 112 on a client 110. The client 110 can represent a variety of computing devices capable of supporting a Web browser 112 and communicating with a Web server 125 over a network 120. Examples of such a client 110 can include, but are not limited to, a computer, a mobile phone, a Web-enabled portable media device, a Web-enabled portable game console, and the like.

The Web browser 112 can represent a software application that interprets Web documents written using standardized Web languages to provide a user interface to display the contents of the Web documents and/or execute Web applications. The Web browser 112 can present the user 105 with a search interface 116.

The search interface 116 can be a Web page, a Web application, a right internet application (RIA), and the like that allows the user 105 to interact with a search engine 130. The search interface 116 can be configured to accept one or more search criteria that the search engine 130 uses to generate the search results 145. Upon completion of the search by the search engine 130, the search interface 116 can present the user 105 with the display page 150.

The display page 150 can be a Web document written in a standardized Web language that can be interpreted by the Web browser 112. In addition to basic formatting data, the display page 140 can include the displayed search results 154 and refinement code 152.

The displayed search results 154 can represent a portion of the search results 145 determined by the search engine 130 that have been translated into the standardized Web language for presentation to the user 105. For example, the displayed search results 154 can include twenty-five of the one hundred and fifty total search results 145 found by the search engine 130. In a further example, the displayed search results 154 can be represented as a multitude of HyperText Markup Language (HTML) tags.

The refinement code 152 can represent the code elements added to the display page 150 and/or displayed search results 154 by the search results refinement component 135 that support the refinement menu 114. Incorporation of the refinement code 152 into the display page 150 can include, but is not limited to, event triggers, procedure calls, code blocks, scripts, and the like. For example, JAVASCRIPT onClick event triggers can be added to HTML tags of the displayed search results 154 and the corresponding JAVASCRIPT procedures added to the header of the display page 150. It should be noted that the refinement code 152 used must be supported by the Web browser 112 in order to ensure proper operation.

In another embodiment, the refinement code 152 can include code files (not shown) stored on the Web server 125 that can be accessed by the refinement code 152 within the display page 150. For example, the JAVASCRIPT procedure called from the display page 150 can be contained in a file on the Web server 125.

The refinement code 152 can support the presentation of the refinement menu 114 within the search interface 116 when the display page 150 is interpreted by the Web browser 112. The refinement code menu 114 can represent a listing of refinement commands that the user 105 can select to execute upon the search results 145. The commands listed in the refinement menu 114 can be determined by the search results refinement component 135 and can be based upon information contained in the search results 145. For example, removing search results 145 having a key word of “coffee” can be a command listed in the refinement menu 114 of a search performed for “Java”.

Commands selected from the refinement menu 114 can affect all of the search results 145 determined by the search engine 130 and not only the displayed search results 154. For example, a key word refinement command would affect the displayed search results 154 and search results 145 that are not currently being displayed to the user 105 that contain the selected key word. Then, the displayed search results 154 can be adjusted to match the refined search results 145.

In an embodiment, refinement commands do not invoke the search engine 130, and, therefore, do not introduce any new items into the search results 145. That is, the execution of a refinement command can only decrease the quantity of search results 145. Such an approach is currently unsupported by available search engines 130. This approach can preserve the scope of the search criteria used by the search engine 130 while allowing the user 105 to narrow the focus of the search results 145. Additionally, this approach can increase the efficiency of the Web search because new searches with more detailed criteria are not required.

The search results refinement component 135 can represent a software application configured to enable the refinement menu 114 within the search interface 116. To do so, the search results refinement component 135 can modify the display page 150 to include the refinement code 152 that supports the refinement menu 114 and its commands.

In an alternate embodiment, the search results refinement component 135 can be an integrated element of the search engine 130. In yet another embodiment, the search results refinement component 135 can be located on a Web server (not shown) separate from the search engine 130.

The search engine 130 can represent a software tool that searches documents and/or databases for items matching specified criteria. In system 100, the search engine 130 can represent a variety of search engine 130 types, including, but not limited to, an adaptive search engine, a faceted search engine, a meta search engine, a directory-based search service, and the like. The search engine 130 can produce a set of search results 145, which can be stored within a data store 140 until no longer needed by the user 105.

As used herein, presented data store, including store 140, can be a physical or virtual storage space configured to store digital information. Data store 140 can be physically implemented within any type of hardware including, but not limited to, a magnetic disk, an optical disk, a semiconductor memory, a digitally encoded plastic memory, a holographic memory, or any other recording medium. The data store 140 can be a stand-alone storage unit as well as a storage unit formed from a plurality of physical devices. Additionally, information can be stored within data store 140 in a variety of manners. For example, information can be stored within a database structure or can be stored within one or more files of a file storage system, where each file may or may not be indexed for information searching purposes. Further, data store 140 can utilize one or more encryption mechanisms to protect stored information from unauthorized access.

Network 120 can include any hardware/software/and firmware necessary to convey data encoded within carrier waves. Data can be contained within analog or digital signals and conveyed though data or voice channels. Network 120 can include local components and data pathways necessary for communications to be exchanged among computing device components and between integrated device components and peripheral devices. Network 120 can also include network equipment, such as routers, data lines, hubs, and intermediary servers which together form a data network, such as the Internet. Network 120 can also include circuit-based communication components and mobile communication components, such as telephony switches, modems, cellular communication towers, and the like. Network 120 can include line based and/or wireless communication pathways.

FIG. 2 is a schematic diagram illustrating a search results refinement component 200 in accordance with an embodiment of the inventive arrangements disclosed herein. The search results refinement component 200 can be utilized by system 100 or any other system supporting the refinement of search results.

The search results refinement component 200 can include a refinement menu generator 205, a display page modifier 210, and a refinement applicator 215. The refinement menu generator 205 can be the portion of the search results refinement component 200 configured to determine the commands for the refinement menu.

Commands for the refinement menu can be hard-coded into the refinement menu generator 205 as well as dynamically created from the search results. For example, the meta data of the search results can be examined for data pertaining to key words. In one embodiment, the key words used in the refinement menu can be specific to each search result.

In another embodiment, a complete list of key words and the number of occurrences of each key word can be compiled. From this compiled listing, a preset quantity of the most frequently occurring key words in the search results can be included as commands within the refinement menu. For example, the refinement menu generator 205 can be configured to use the five most frequently occurring key words as “Refinement By Key Word” commands.

With the refinement menu commands determined, the display page modifier 210 can be invoked to modify the contents of the Web document displaying the search results in order to support the refinement menu. Supporting the refinement menu can involve the incorporation of additional code into the Web document. It should be noted that modifications made to the display page for the search results must correspond to the type of Web document being modified as well as the Web browser that will interpret the modified Web document.

When a user selects a command from the refinement menu, the refinement applicator 215 can be invoked. The refinement applicator 215 can represent the portion of the search results refinement component 200 configured to execute the software code associated with the selected command. For example, upon the selection of a command to remove the search result numbered fourteen, the refinement applicator 215 can remove the data that corresponds to number fourteen from the search results.

Additionally, the refinement applicator 215 can replace the item removed from the display with a remaining search result, when additional search results are available for display. Building on the previous example, the data displayed in number fourteen can be replaced with the data for number twenty-six, which is the next search result on the list that is currently not being displayed.

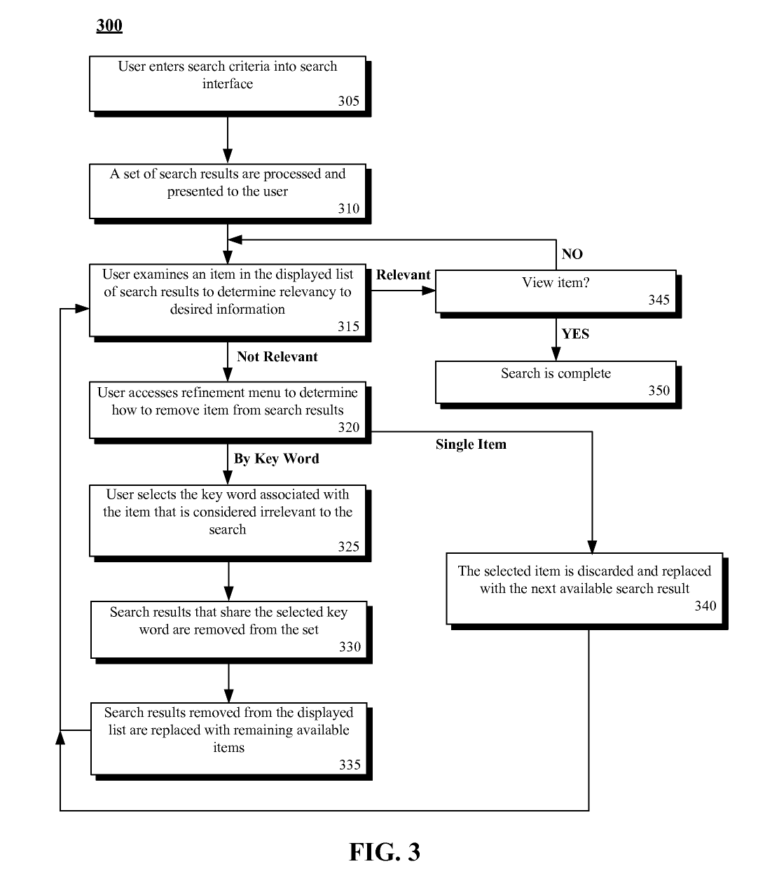

FIG. 3 is a flow chart of a method 300 for providing a refinement capability for a set of search results while preserving the scope of the search criteria in accordance with an embodiment of the inventive arrangements disclosed herein. Method 300 can be performed in the context of system 100 and/or utilizing search results refinement component 200.

Method 300 can begin with step 305 where a user can enter search criteria into a search interface. In step 310, a set of search results can be processed and presented to the user. The user can examine an item in list of search results to determine its relevancy to the desired information in step 315.

When the user deems the item as not relevant, step 320 can execute where the user accesses the refinement menu to determine how to remove the item from the search results. In step 325, the user can elect a “By Key Word” option and can select a key word that is associated with the item that they feel is irrelevant to the search.

Other search results that share the selected key word are removed from the set of search results in step 330. In step 335, the search results that were removed from the displayed list in step 330 can be replaced with remaining available search results. From step 335, flow can return to step 315.

From step 320, the user can elect to remove a “Single Item”, which executes step 340 where the selected item can be discarded and replaced with the next available search result. Upon completion of step 340, flow can return to step 315.

When a user deems the item to be relevant to their search in step 315, then step 345 can execute where the user can decide to view the item. If the user does not wish to view the item, flow returns to step 315. When the user chooses to view the item, step 350 can execute where the search is deemed complete.

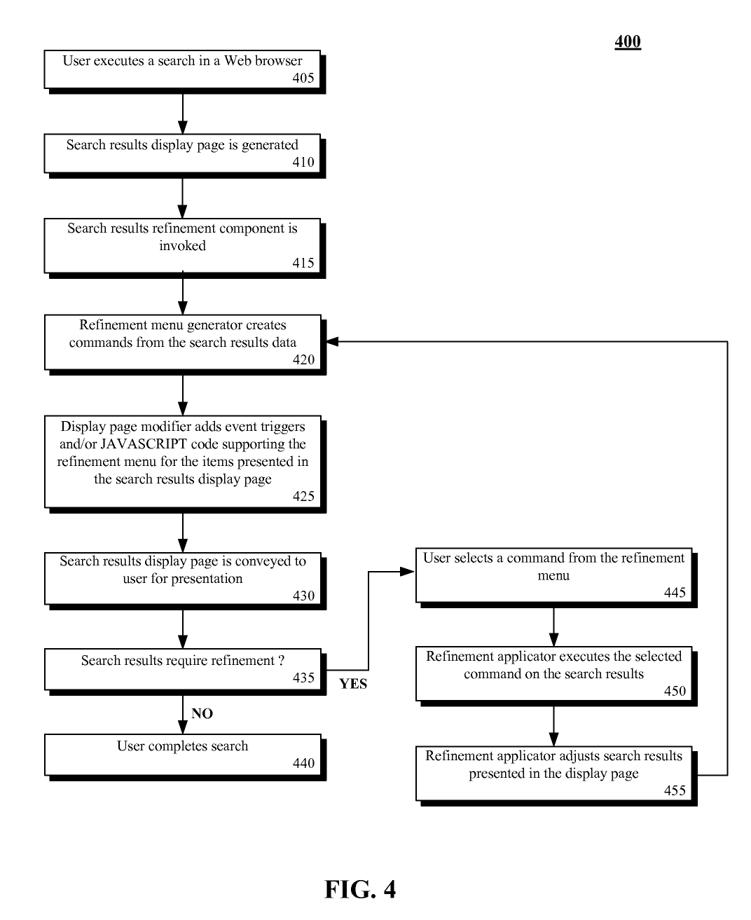

FIG. 4 is a flow chart of a method 400 outlining the interactions of a search results refinement component in accordance with an embodiment of the inventive arrangements disclosed herein. Method 400 can be performed in the context of system 100 and/or method 300 as well as by the search results refinement component 200 of FIG. 2.

Method 400 can begin in step 405, when a user executes a search in a Web browser. In step 410, the search results display page can be generated. The search results refinement component can be invoked in step 415.

In step 420, the refinement menu generator can create commands from the search results data. The display page modifier can add event triggers and/or JAVASCRIPT code that support the refinement menu for the items presented in the search results display page in step 425.

In step 430, the modified search results display page can be conveyed to the user for presentation. The need for refinement to the search results can be determined in step 435. When refinement is needed, step 445 can execute where the user can select a command from the refinement menu.

In step 450, the refinement applicator can execute the selected command on the search results. The refinement applicator can adjust the search results presented in the display page in step 455. From step 455, flow can return to step 420.

When refinement of the search results is unnecessary, step 440 can execute where the user completes the search.

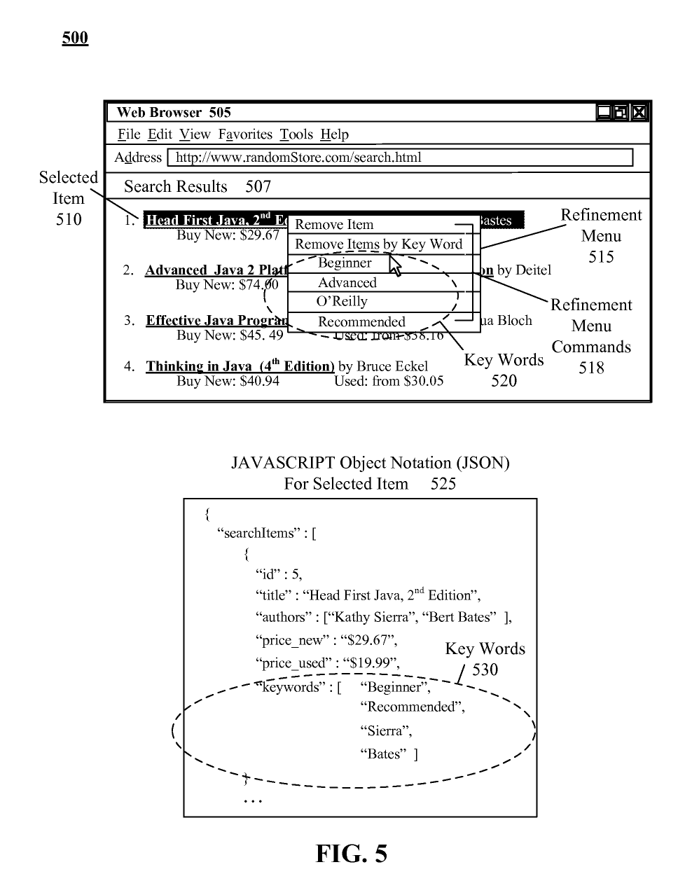

FIG. 5 is an example 500 depicting the enablement of a refinement menu 515 in accordance with an embodiment of the inventive arrangements disclosed herein. As shown in example 500, the Web browser 505 can display search results 507 and a refinement menu 515.

The display of the refinement menu 515 can be in response to the user performing an action on a selected item 510. For example, the refinement menu 515 can be displayed by clicking the right mouse button on the selected item 510.

The refinement menu 515 can contain refinement menu commands 518. In this example 500, the refinement menu 515 includes a command 518 to remove an item and multiple commands 518 to remove items based on a key word 520. The key words 520 for the commands 518 of the refinement menu 515 can correlate to those key words 530 associated with the selected item 510.

Examination of the search result data can identify the key words 530 for the search results 507. In this example 500, the search results 507 have been converted into JAVASCRIPT objects. The included text 525 can represent a JAVASCRIPT Object Notation (JSON) for the selected item 510.

As shown, the JSON 525 can include many attribute-value sets that represent important information for the selected item 510. Of particular note is the “keywords” attribute 530 whose associated data values correspond to the key words 520 displayed as commands 518 of the refinement menu 510.

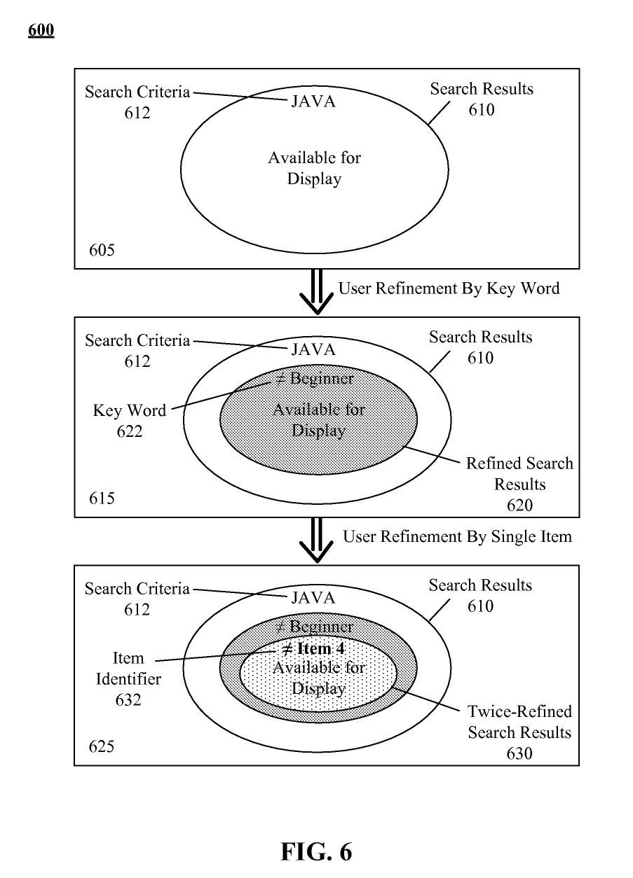

FIG. 6 is a collection 600 of illustrations 605, 615, 625 that graphically depict the refinement of search results 610 in accordance with an embodiment of the inventive arrangements disclosed herein. Illustration 605 can represent the search results 610 for the execution of a search using the criteria 612. As shown in this example, the white oval represents the set of search results 610 for the criteria 612 “JAVA”. All of these search results 610 can be made available for display to the user.

Illustration 615 can represent the change produced by the execution of a refinement command. In this example, a refinement is made using the key word “Beginner” 622. The grey oval can represent the set of refined search results 620, which are the only items of the search results 610 that can be displayed to the user. Any items located in the white oval can no longer be accessed by the user because these items have the key word 622 associated with them.

Illustration 625 can represent the change produced by the execution of a second refinement command. In this example, a refinement is made by a single item 632. The dotted oval can represent the set of twice-refined search results 630, which are the only items of both the search results 610 and the refined search results 620 that can be displayed to the user. In this example, only the item with an identifier 632 of “4” can be located in the grey oval and can no longer be accessed by the user.

Additional refinements can be performed that reduce the quantity of the search results 610 that are available to the user. With this approach, the user can systematically narrow the search results 610 until a desired item is found.

The diagrams in FIGS. 1-6 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing a refinement capability for search results while preserving the scope of the search criteria comprising:
providing a Web document containing a plurality of search results, wherein the plurality of search results are determined by a search engine, wherein said Web document further comprises refinement code comprising user configurable options applicable to the search results;
receiving a user input associated with the refinement code, said user input representing a user issued refinement command;
executing the user issued refinement command upon the plurality of search results, wherein the executing of the user issued refinement command occurs without an additional search being conducted by the search engine; and
conveying refinement results from the user issued refinement command, wherein said refinement results comprise a subset of the plurality of search results.

2. The method of claim 1, wherein the subset of the search results consists of a set from zero to the total number of search results determined by the search engine.

3. The method of claim 1, wherein the user issued refinement command results from a user selection of an option from a refinement menu, details of which are defined by the refinement code.

4. The method of claim 1, wherein the executing step further comprises:
excluding from the refinement results at least one search result of the search results in accordance with the user issued refinement command.

5. The method of claim 1, further comprising:
identifying an original Web document that lacks the refinement code, wherein the original Web document is a document produced by the search engine; and
creating said Web document comprising the refinement code based upon the original Web document.

6. The method of claim 1, further comprising:
analyzing data associated with the plurality of search results for key words;
determining a frequency for each key word within the plurality of search results; and
defining within the refinement code said key words and said determined frequency for each of said key words.

7. The method of claim 6, wherein said user issued refinement command specifies at least one user specified key word and at least one user specified word frequency value, said method further comprising:
comparing the user specified word frequency value against the determined frequency to programmatically determine which ones of the search results are to be included in the refinement results.

8. A computer program product for providing a refinement capability for search results while preserving the scope of the search criteria, the computer program product comprising:
a computer usable medium having computer usable program code embodied therewith, the computer usable program code comprising:
computer usable program code configured to provide a Web document containing a plurality of search results, wherein the plurality of search results are determined by a search engine, wherein said Web document further comprises refinement code comprising user configurable options applicable to the search results;
computer usable program code configured to receive a user input associated with the refinement code, said user input representing a user issued refinement command;
computer usable program code configured to execute the user issued refinement command upon the plurality of search results, wherein the executing of the user issued refinement command occurs without an additional search being conducted by the search engine; and
computer usable program code configured to convey refinement results from the user issued refinement command, wherein said refinement results comprises a subset of the plurality of search results.

9. A system for providing a refinement capability for search results while preserving the scope of the search criteria comprising:
a search engine configured to determine search results for at least one user-provided search criteria;
a search results refinement component configured to allow a user-directed refinement of the search results, wherein the user-directed refinement removes at least one item contained within the search results, and, wherein the search engine remains inactive during an execution of the user-directed refinement wherein a scope of the at least one user-provided search criteria is preserved; and
a search interface configured to present the search results and to provide an interaction mechanism for the execution of the user-directed refinement upon the search results.

10. The system of claim 9, wherein the search results refinement component further comprises:
a refinement menu generator configured to determine at least one user-selectable menu item for the search results to be presented in a refinement menu;
a display page modifier configured to enable a presentation of the refinement menu within the search interface; and
a refinement applicator configured to restrict the search results displayed within the search interface based upon a user-selection from the refinement menu.

11. The system of claim 10, wherein the display page modifier is configured to alter a Web document written in a standardized language to contain additional machine-readable code, wherein the Web document provides a framework for presenting the search results.

12. The system of claim 11, wherein the additional machine-readable code is written in a standardized Web scripting language.

13. The system of claim 9, wherein the user-directed refinement of the search results comprises at least one of a removal by a key word and a removal of a specific search result.

14. The system of claim 9, wherein the search engine is an adaptive search engine, wherein the adaptive search engine is configured to track the user-directed refinement of the search results to influence future searches.

15. The system of claim 9, wherein the search results refinement component is configured to asynchronously update the search results within the search interface.

16. The system of claim 9, wherein the search results refinement component is a plug-in element of the search engine.

17. A software application providing a refinement capability for search results while preserving the scope of the search criteria comprising:
a refinement menu generator configured to determine at least one user-selectable menu item for the search results to be presented in a refinement menu;
a display page modifier configured to enable a presentation of the refinement menu within a search interface; and
a refinement applicator configured to restrict the plurality of search results displayed within the search interface based upon a user-selection from the refinement menu.

18. The software application of claim 17, wherein the display page modifier is configured to alter a Web document written in a standardized language to contain additional machine-readable code, wherein the Web document provides a framework for presenting the plurality of search results.

19. The software application of claim 17, wherein the user-directed refinement of the search results comprises at least one of a removal by a key word and a removal of a specific search result.

20. The software application of claim 17, wherein the refinement applicator is configured such that a restriction of the plurality of search results displayed within the search interface occurs asynchronously.
